(19) United States
(12) Patent Application Publication
(10) Pub. No.: US 2023/0090287 A1
(43) Pub. Date: Mar. 23, 2023

(54) GREASE COMPOSITION AND GREASE-SEALED BEARING

(71) Applicant: NTN CORPORATION, Osaka (JP)

(72) Inventor: Takayuki KAWAMURA, Mie (JP)

(21) Appl. No.: 17/794,250

(22) PCT Filed: Jan. 15, 2021
(86) PCT No.: PCT/JP2021/001151

§ 371 Date: Jul. 20, 2022

(30) Foreign Application Priority Data
Jan. 31, 2020 (JP) 2020-015327

(51) Int. Cl. F16C 33/66

(52) U.S. Cl. CPC F16C 33/6633

(57) ABSTRACT

To provide a grease composition that is capable of effectively preventing an early-flaking caused by hydrogen embrittlement, and a grease-sealed bearing in which the grease composition is sealed. A grease composition 7 contains a base oil, a thickener, and an additive. The additive contains sodium molybdate, and zinc alkyldithiophosphate having a 1-30 C primary alkyl group. The grease composition contains 0.1-5 mass % of the sodium molybdate relative to the whole of the grease composition. The grease composition contains 0.1-5 mass % of the zinc alkyldithiophosphate relative to the whole of the grease composition.

### TECHNICAL FIELD

The present invention relates to a grease composition and a grease-sealed bearing in which the grease composition is sealed. In particular, the present invention relates to a grease composition used in a rolling bearing for automobile electric devices or automobile auxiliary devices, and a grease-sealed bearing in which the grease composition is sealed.

### BACKGROUND ART

A rolling bearing has been used in a rotational portion of each part such as an automobile electric device, an automobile auxiliary device, and a motor in an industrial machine. Examples of the automobile electric device and the automobile auxiliary device include an alternator, a pulley, an electromagnetic clutch for automobile air conditioners, a fan coupling device, and an electric fan motor. An idler pulley for automobiles is used as a belt tensioner for a driving belt that transmits rotation of a combustion engine to the automobile auxiliary device. Grease is sealed in the rolling bearing used for these devices in order to impart a lubrication property thereto.

As a use condition of the rolling bearing becomes severe, a specific flaking with white structure change is caused on a rolling surface early. This specific flaking is a break phenomenon caused from a relatively near portion from the rolling surface, which is different from the flaking from an inside of the rolling surface caused by general metal fatigue. It has been considered that this specific flaking is hydrogen embrittlement caused by hydrogen. For example, it is considered that, when the grease is decomposed and thus hydrogen is generated, the hydrogen invades the steel of the rolling bearing, so that the early-flaking is caused due to the hydrogen embrittlement. The fatigue strength of the steel is largely deteriorated by hydrogen. Thus, even in a condition of elastic fluid lubrication in which the contact parts are separated by oil film, a crack is caused near the inside of the rolling surface on which the maximum alternate shear stress is caused, and then the crack is propagated to cause the early-flaking.

Conventionally, various methods have been considered for preventing the specific flaking phenomenon with the white structure change caused early. For example, a method that adds molybdate and organic salt as additives into the grease has been disclosed (see Patent Document 1) .

### PRIOR ART DOCUMENT

### Patent Document

Patent Document 1: JP 2005-112902 A

### SUMMARY OF THE INVENTION

### Problems to be Solved by the Invention

In recent years, rapid acceleration and rapid deceleration are added together with high temperature and high speed into the use condition of the rolling bearing, and thus the use condition becomes severe more and more. In the severe condition, surface pressure on a portion between a rolling element and a raceway ring is increased and sliding is largely caused due to the rapid acceleration and the rapid deceleration. Consequently, the break of oil film (lubrication failure) on such portion is caused easily. Thus, further improved method has been required for preventing the early-flaking in such an environment.

An object of the present invention is, in order to solve such problems, to provide a grease composition that is capable of effectively preventing early-flaking caused by hydrogen embrittlement, and further to provide a grease-sealed bearing in which the grease composition is sealed.

### Means for Solving the Problems

A grease composition of the present invention comprises a base oil, a thickener, and an additive. The additive contains sodium molybdate, and zinc alkyldithiophosphate having a 1-30 C primary alkyl group.

The grease composition may contain 0.1-5 mass % of the sodium molybdate relative to the whole of the grease composition. Further, the grease composition may contain 0.1-5 mass % of the zinc alkyldithiophosphate relative to the whole of the grease composition.

The thickener may be a diurea compound. Further, the base oil may contain poly-α-olefin oil (hereinafter, also referred to as a PAO oil).

The grease composition may be configured as a grease composition not containing zinc alkyldithiophosphate having a secondary alkyl group.

A grease-sealed bearing of the present invention comprises an inner ring, an outer ring, a plurality of rolling elements interposed between the inner ring and the outer ring, and a grease composition sealed around the rolling elements. The grease composition is configured as the above-described grease composition of the present invention.

### Effect of the Invention

The grease composition of the present invention contains the sodium molybdate and the zinc alkyldithiophosphate having a 1-30 C primary alkyl group, as an additive. Thus, the grease is prevented from decomposing and hydrogen is prevented from invading into steel material by the formation of oxide film of the sodium molybdate and the formation of coating film due to the zinc alkyldithiophosphate having the primary alkyl group. As a result, the early-flaking caused by the hydrogen embrittlement can be effectively prevented.

The grease composition of the present invention does not contain zinc alkyldithiophosphate having a secondary alkyl group. Thus, the grease composition does not inhibit the formation of the oxide film of the sodium molybdate, so that the grease composition can bring an early-flaking resistant property derived from the oxide film of the sodium molybdate.

The grease-sealed bearing of the present invention comprises the inner ring, the outer ring, a plurality of the rolling elements interposed between the inner ring and the outer ring, and the grease composition of the present invention sealed around the rolling elements. Thus, the early-flaking caused by the hydrogen embrittlement can be prevented even in a severe use condition, and accordingly a longtime use of the bearing can be realized.

### BRIEF DESCRIPTION OF THE DRAWINGS

FIG. 1 is a sectional view showing a deep groove ball bearing as one example of a grease-sealed bearing according to the present invention.

FIG. 2 is a sectional view showing an alternator including the grease-sealed bearing according to the present invention.

### MODE FOR CARRYING OUT THE INVENTION

The present inventors conducted a study relating to a grease composition for lubrication in order to prevent early-flaking from causing on a rolling surface due to hydrogen embrittlement. As a result, the present inventors found that an early-flaking preventive resistant property that is unexpectedly superior can be obtained using sodium molybdate, and zinc alkyldithiophosphate having a primary alkyl group. The present invention is derived from such knowledge.

A grease composition of the present invention contains abase oil, a thickener, and an additive. The additive contains sodium molybdate, and zinc alkyldithiophosphate having a 1-30 C primary alkyl group.

Any of sodium molybdate anhydride and sodium molybdate hydrate may be employed in the present invention. It is preferable that the compounding amount of the sodium molybdate is 0.1-5 mass %, more preferably 0.1-2 mass %, further more preferably 1-2 mass %, relative to the whole of the grease composition. In a case in which the compounding amount of the sodium molybdate is less than 0.1 mass %, the flaking resistance is not sufficiently obtained.

The sodium molybdate reacts with a friction wear surface or an iron-based metal newly formed surface exposed by the wear, of the bearing part so as to form iron oxide and a film containing a molybdenum compound, on the surface of the bearing part. When the metal newly formed surface caused by the wear is covered with the iron oxide and the molybdenum compound film, decomposition of the grease, which is caused by the metal newly formed surface serving as a catalyst, is suppressed, so that hydrogen is restricted from causing.

Zinc alkyldithiophosphate employed in the present invention is zinc alkyldithiophosphate having a 1-30 C primary alkyl group (hereinafter, referred to as pri-ZnDTP). In the present invention, the pri-ZnDTP is represented by the following formula (1)

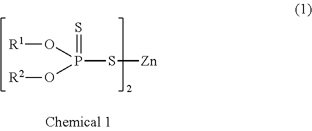

In the formula (1) , each of R¹ and R² denotes a 1-30 C primary alkyl group. The primary alkyl group means that a carbon atom directly bonded to an oxygen atom in the zinc alkyldithiophosphate in each of the substituent groups R¹ and R² is a primary carbon atom. Examples of each of the substituent groups R¹ and R² include a methyl group, an ethyl group, a propyl group, a butyl group, an isobutyl group, a pentyl group, an isopentyl group, a hexyl group, an isohexyl group, a 2-ethylhexyl group, a heptyl group, an octyl group, a nonyl group, a decyl group, a dodecyl group, a tetradecyl group, a hexadecyl group, an octadecyl group, an eicosyl group, a docosyl group, and a tetracosyl group. The substituent groups R¹ and the substituent groups R² maybe identical to or different from each other. On the formula (1), each of the substituent groups R¹ and R² is preferably a 6-24 C primary alkyl group, more preferably an 8-16 C primary alkyl group.

The present invention employs the pri-ZnDTP as the zinc alkyldithiophosphate, so that the early-flaking on the rolling surface can be effectively prevented by a synergistic effect of the zinc alkyldithiophosphate and the sodiummolybdate . One kind of the pri-ZnDTP represented by the above-described formula (1) may be employed, or alternatively a combination of two or more kinds of the pri-ZnDTPs maybe employed. An example of the pri-ZnDTP that is commercially available includes Lubrizol 1097 produced by Lubrizol Corporation.

The compounding amount of the pri-ZnDTP is preferably 0.1-5 mass %, more preferably 0.1-2 mass %, further more preferably 1-2 mass %, relative to the whole of the grease composition. In a case in which the compounding amount of the pri-ZnDTP is less than 0.1 mass o, the synergistic effect is not sufficiently obtained.

It is preferable that the grease composition of the present invention does not contain the ZnDTP having a secondary alkyl group (hereinafter, referred to as a sec-ZnDTP) represented by the following formula (2).

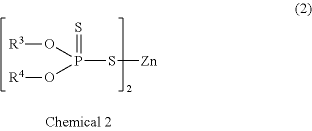

In the formula (2) , at least one of R³ and R⁴ is a secondary alkyl group. The secondary alkyl group means that a carbon atom directly bonded to an oxygen atom in the zinc alkyldithiophosphate in each of the substituent groups R³ and R⁴ is a secondary carbon atom. Examples of the secondary alkyl group include an isopropyl group, a secondary butyl group, a 1-methylbutyl group, a 1-methylpentyl group, a cyclopentyl group, a cyclohexyl group, and a cycloheptyl group.

The sec-ZnDTP is easy to decompose and react with a steel material, and thus the sec-ZnDTP might inhibit the formation of the oxide film of the sodium molybdate. On the other hand, the pri-ZnDTP has superior stability. Thus, the grease composition that does not contain the sec-ZnDTP allows the sodium molybdate to form the oxide film easily.

Further, it is preferable that the grease composition of the present invention does not contain a wear preventive agent other than the material represented by the above-described formula (1). Examples of the wear preventive agent include: in addition to the sec-ZnDTP; zinc diaryldithiophosphate in which an aryl group is directly bonded to an oxygen atom in the zinc dialkyldithiophosphate; zinc alkyldithiocarbamate (ZnDTC); molybdenum alkyldithiophosphate (MoDTP); and molybdenum alkyldithiocarbamate (MoDTC).

A base oil employed in the grease composition of the present invention is not especially limited as long as the base oil is normally used in a rolling bearing. Examples of the base oil include mineral oil such as paraffin mineral oil and naphthenic mineral oil, synthetic hydrocarbon oil such as PAO oil and alkylbenzene oil, ester oil, ether oil, silicone oil, and fluorine oil. Any one of these base oils may be employed alone, or a combination of two or more of these base oils may be employed. The base oil preferably contains at least the synthetic hydrocarbon oil.

The PAO oil is preferable as the synthetic hydrocarbon oil. The PAO oil is α-olefin or isomerized α-olefin oligomer or polymer compound. Examples of the α-olefin includes 1-Octene, 1-Nonene, 1-Decene, 1-Dodecene, 1-Tridecene, 1-Tetradecene, 1-Pentadecene, 1-Hexadecene, 1-Heptadecene, 1-Octadecene, 1-Nonadecene, 1-Eicosene, 1-Docosene, and 1-Tetradocosene. Normally, a mixture of any these α-olefins is employed.

Examples of a further preferable aspect of the base oil include the base oil formed of only the PAO oil, a mixed base oil formed of the PAO oil and the ether oil, and a mixed base oil of the PAO oil and the ester oil. Alkyldiphenylether oil is preferable among the above ether oils because of its superior oxidation stability and high temperature resistance.

Dynamic viscosity of the base oil (in a case of mixed oil, the dynamic viscosity of the mixed oil) at 40° C. is preferably 20-150 mm²/s, more preferably 20-100 mm²/s, further more preferably 40-80 mm²/s.

The base oil is preferably contained by 60-95 mass % to a total amount (base grease) of the base oil and the thickener. In a case in which the content of the base oil is less than 60 mass %, the lifetime might be reduced. In case in which the content of the base oil is more than 95 mass %, the thickener is relatively decreased and thereby it might be difficult to be turned into a greasy state. The base oil is more preferably contained by 80-90 mass % to the total amount of the base oil and the thickener.

The thickener used in the grease of the present invention is not especially limited, and therefore a general thickener normally used in a field of grease may be adopted. For example, soap-based thickener such as metal soap and complex metal soap, or non-soap-based thickener such as bentone, silica gel, diurea compound, triurea compound, tetraurea compound and urea-urethane compound may be adopted. Examples of the metal soap include sodium soap, calcium soap and lithium soap. An example of the complex metal soap includes complex lithium soap. Of these thickeners, it is preferable to adopt the diurea compound as the thickener.

The diurea compound is obtained by causing a diisocyanate component and a monoamine component to react with each other. Examples of the diisocyanate component include phenylene diisocyanate, and diphenylmethane diisocyanate (MDI) . As the diurea compound, aliphatic diurea compound, alicyclic diurea compound, or aromatic diurea compound may be adopted, which are distinguished by a kind of substituent group of the used monoamine component. Ina case of the aliphatic diurea compound, aliphatic monoamine (octyl amine or the like) is adopted as the monoamine component. In a case of the alicyclic diurea compound, alicyclic monoamine (cyclohexylamine or the like) is adopted as the monoamine component. In a case of the aromatic diurea compound, aromatic monoamine (p-toluidine or the like) is adopted as the monoamine component.

The base grease containing the diurea compound as the thickener is produced by causing the diisocyanate component and the monoamine component to react with each other in the base oil. A compound rate of the thickener in the base grease is preferably 5-30 mass %, and more preferably 10-20 mass %.

Other additive (s) may be further added to the grease composition of the present invention to such an extent that does not deteriorate the nature of the present invention. Examples of the additives include an antioxidant such as amine-based compound, phenol-based compound and sulfur-based compound, an antirust agent such as sulfonate and polyhydric alcohol ester, and an oily agent such as ester and alcohol.

The worked penetration (JIS K 2220) of the grease composition of the present invention is preferably in a range of 200-350. In a case in which the worked penetration is less than 200, a lack of lubrication might be caused because of less oil separation. In a case in which the worked penetration is more than 350, the grease composition is so soft that the grease composition is liable to undesirably leak out of the bearing. The worked penetration is more preferably in a range of 250-300.

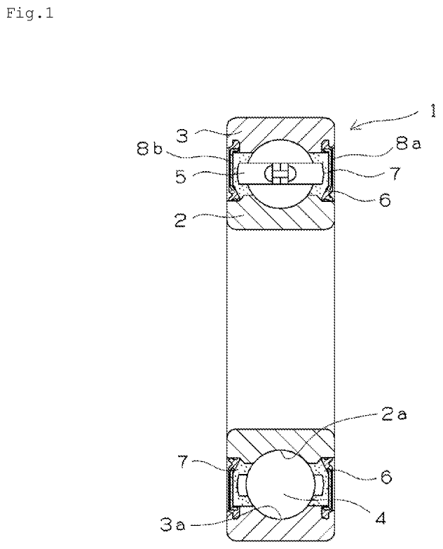

A grease-sealed bearing in which the grease composition of the present invention is sealed is described with reference to FIG. 1. FIG. 1 is a sectional view of a deep groove ball bearing. A rolling bearing 1 includes an inner ring 2 having an inner ring rolling surface 2a on an outer peripheral surface thereof, an outer ring 3 having an outer ring rolling surface 3a on an inner peripheral surface thereof, and a plurality of rolling elements 4. The inner ring 2 and the outer ring 3 are arranged coaxially with each other. The rolling elements 4 are arranged between the inner ring rolling surface 2a and the outer ring rolling surface 3a. The rolling elements 4 are retained by a cage 5. Axial end openings 8a, 8b between the inner ring and the outer ring are sealed by seal members 6. The above-described grease composition 7 is sealed around at least the rolling elements 4. Each of the inner ring 2, the outer ring 3, and the rolling elements 4 is formed of iron-based metal material. The inner ring 2, the outer ring 3, and the rolling elements 4 are lubricated by the grease composition 7 interposed between the rolling elements 4 and the rolling surfaces.

The iron-based metal material that forms the bearing component such as the inner ring 2, the outer ring 3, the rolling elements 4 and the cage 5 in the rolling bearing 1 is any material generally used as a bearing material. Examples of the iron-based metal material include high carbon chromium bearing steel (SUJ 1, SUJ 2, SUJ 3, SUJ 4, SUJ 5, and the like; JIS G 4805) , cement steel (SCr 420, SCM 420, and the like; JIS G4053), stainless steel (SUS 440C and the like; JIS G4303), high-speed steel (M 50 and the like), and cold-rolled steel. The seal member 6 may be formed as a single body of metal or rubber molded body, or alternatively the seal member 6 may be formed as a complex body of the rubber molded body and a metal plate, a plastic plate, or a ceramic plate. The complex body of the rubber molded body and the metal plate is preferable from a viewpoint of durability and easiness of adhesion.

FIG. 1 exemplarily shows a ball bearing as a bearing, however the grease-sealed bearing of the present invention can be applied to a cylindrical roller bearing, a tapered roller bearing, a self-aligning roller bearing, a needle roller bearing, a thrust cylindrical roller bearing, a thrust tapered roller bearing, a thrust needle roller bearing, and a thrust self-aligning roller bearing, in addition to the above-described ball bearing.

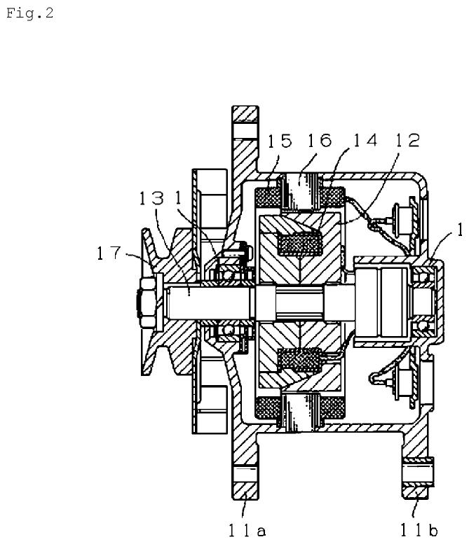

A configuration in which the grease-sealed bearing of the present invention is applied to an automobile electric device or an automobile auxiliary device is described with reference to FIG. 2. FIG. 2 is a sectional view showing a structure of an alternator. The alternator includes a pair of frames 11a, 11b serving as a housing, which is a fixed member, and a rotor rotational shaft 13 to which a rotor 12 is mounted. The rotor rotational shaft 13 is rotatably supported by a pair of the frames 11a, 11b using a pair of rolling bearings 1, 1 in which the above-described grease composition is sealed. A rotor coil 14 is mounted to the rotor 12. A three-phase stator coil 16 wound at each 120 degrees is mounted to a stator 15 arranged outside the rotor 12. The rotor rotational shaft 13 is rotationally driven by rotational torque transmitted by a belt (not shown) via a pulley 17 mounted to a distal end of the rotor rotational shaft 13. The pulley 17 is mounted to the rotor rotational shaft 13 in a cantilever manner. The pulley 17 vibrates in response to a high speed rotation of the rotor rotational shaft 13, and thus a severe load is applied to, in particular, the rolling bearing 1 that supports the rotor rotational shaft 13 at the side of the pulley 17.

### EXAMPLE

The present invention is now specifically described using examples and comparative examples. However, the present invention is not limited to those examples.

Each of the grease compositions having components shown in Table 1 was produced. The content of each of the base oil and the thickener in Table 1 shows a content rate (mass %) relative to the base grease (the base oil+the thickener). The content of the additive shows a content rate (mass %) relative to the whole of the grease composition. In each of the grease compositions in Examples 1 to 4, only the sodium molybdate and the pri-ZnDTP are compounded as the additive.

A rapid acceleration and deceleration test was executed by simulating the alternator as one example of the electric auxiliary device, using an inner ring rotating rolling bearing (the inner ring, the outer ring and the steel balls are formed of bearing steel SUJ 2) that supports the rotation shaft. Each produced grease composition was sealed in each rolling bearing. A load of 2,334 N applied to the pulley mounted to the distal end of the rotational shaft and a rotation speed of 0-18,000 rpm are set as a driving condition. The test was executed in a state in which an electric current of 1.0 A is applied to the bearing (6203) to be tested. The time (flaking generation lifetime, hours) until the test is stopped when the abnormal flaking is generated in the bearing and the vibration detector detects the vibration more than a set value. Table 1 shows the average lifetime of six bearings in each example.

TABLE 1

| | Example | | | | Comparative example | | | | | | |
|---|---|---|---|---|---|---|---|---|---|---|---|
| | 1 | 2 | 3 | 4 | 1 | 2 | 3 | 4 | 5 | 6 | 7 |
| Base oil + Thickener | | | | | | | | | | | |
| (mass %) | | | | | | | | | | | |
| Base oil | | | | | | | | | | | |
| Alkyldiphenylether | — | — | — | 20 | — | — | 20 | — | — | — | — |
| oil 1) | | | | | | | | | | | |
| Synthetic | 25 | 85 | 25 | 60 | 25 | 85 | 60 | 25 | 25 | 25 | 25 |
| hydrocarbon oil 2) | | | | | | | | | | | |
| Ester oil 3) | 60 | — | 60 | — | 60 | — | — | 60 | 60 | 60 | 60 |
| Thickener | | | | | | | | | | | |
| Amine: p-toluidine | — | — | — | 9.3 | — | — | 9.3 | — | — | — | — |
| Amine : | 3.1 | 3.1 | 3.1 | — | 3.1 | 3.1 | — | 3.1 | 3.1 | 3.1 | 3.1 |
| cyclohexylamine | | | | | | | | | | | |
| Amine: octyl amine | 4.1 | 4.1 | 4.1 | — | 4.1 | 4.1 | — | 4.1 | 4.1 | 4.1 | 4.1 |
| Diisocyanate (MDI) | 7.8 | 7.8 | 7.8 | 10.7 | 7.8 | 7.8 | 10.7 | 7.8 | 7.8 | 7.8 | 7.8 |
| Additive (mass %) | | | | | | | | | | | |
| pri-ZnDTP 4) | 2 | 1 | 2 | 2 | — | — | — | — | — | 2 | — |
| sec-ZnDTP 5) | — | — | — | — | 2 | 1 | 2 | — | 2 | — | 2 |
| Sodium molybdate | 2 | — | — | — | 2 | — | — | — | — | — | — |
| (anhydride) 6) | | | | | | | | | | | |
| Sodium molybdate | — | 2 | 2 | 2 | — | 2 | 2 | 2 | — | — | 2 |
| (hydrade) 7) | | | | | | | | | | | |
| Rapid acceleration and | | | | | | | | | | | |
| deceleration test | | | | | | | | | | | |
| Flaking generation | 44 | 46 | 47 | 52 | 25 | 24 | 26 | 33 | 23 | 21 | 23 |
| lifetime (hours) | | | | | | | | | | | |

1) Moresco Hilube LB100 produced by MORESCO Corporation, dynamic viscosity of 97 mm²/s at 40° C.
2) PAO801 produced by NIPPON STEEL Chemical & Material Co., Ltd., dynamic viscosity of 47 mm²/s at 40° C.
3) Unister H-381R produced by NOF CORPORATION, dynamic viscosity of 49 mm²/s at 40° C.
4) Lubrizol1097 produced by Lubrizol Corporation
5) Lubrizol667A produced by Lubrizol Corporation
6) Sodium molybdate produced by FUJIFILM Wako Pure Chemical Corporation
7) Sodium molybdate produced by FUJIFILM Wako Pure Chemical Corporation

In Comparative example 4 in Table 1, only the sodium molybdate is compounded as the additive. In Examples 1 to 4 using the sodium molybdate and the pri-ZnDTP, each of the flaking lifetimes extends more than 1.3 times as long as that of Comparative example 4. In particular, in Example 4 using the aromatic diurea compound as the thickener, the flaking lifetime extends more than 1.5 times as long as that of Comparative example 4. In Comparative examples 1 to 3 and 7 using the sodium molybdate and the sec-ZnDTP, each of the flaking lifetimes reduces largely compared to Comparative example 4.

As described above, the early-flaking resistant property is largely different between the configuration using the sodium molybdate and the pri-ZnDTP and the configuration using the sodium molybdate and the sec-ZnDTP. That is, the configuration using the sodium molybdate and the pri-ZnDTP shows a synergistic effect, while the configuration using the sodium molybdate and the sec-ZnDTP deteriorates the early-flaking resistant property of the sodium molybdate. In Comparative example 5 using only the sec-ZnDTP as the additive, the flaking lifetime becomes longer than that of Comparative example 6 using only the pri-ZnDTP.

### INDUSTRIAL APPLICABILITY

The grease composition of the present invention can effectively prevent the specific early-flaking with white structure change caused on the rolling surface, so that superior bearing lifetime of the rolling bearing can be obtained. The rolling bearing is suitable to, in particular, a rolling bearing and a motor bearing in an automobile electric device or an automobile auxiliary device such as an alternator, an electromagnetic clutch for automobile air conditioners, an intermediate pulley and an electric fan motor.

### REFERENCE SIGNS LIST 1: rolling bearing 2: inner ring 3: outer ring 4: rolling element 5: cage 6: seal member 7: grease 8a, 8b: opening

11a, 11b: frame

12: rotor

13: rotor rotational shaft

14: rotor coil

15: stator

16: stator coil

17: pulley

1. A grease composition comprising a base oil, a thickener, and an additive, wherein the additive contains sodium molybdate, and zinc alkyldithiophosphate having a 1-30 C primary alkyl group.

2. The grease composition as defined in claim 1, wherein:
the grease composition contains 0.1-5 mass % of the sodium molybdate relative to the whole of the grease composition, and the grease composition contains 0.1-5 mass % of the zinc alkyldithiophosphate relative to the whole of the grease composition.

3. The grease composition as defined in claim 1, wherein the thickener is a diurea compound.

4. The grease composition as defined in claim 1, wherein the base oil contains poly-α-olefin oil.

5. The grease composition as defined in claim. 1, wherein the grease composition does not contain zinc alkyldithiophosphate having a secondary alkyl group.

6. A grease-sealed bearing comprising:
an inner ring;
an outer ring;
a plurality of rolling elements interposed between the inner ring and the outer ring; and
a grease composition sealed around the rolling elements, the grease composition being defined in claim 1.
